(19) United States
(12) Patent Application Publication
(10) Pub. No.: US 2005/0249390 A1
(43) Pub. Date: Nov. 10, 2005

(54) Method and apparatus for discriminating ambient light in a fingerprint scanner

(76) Inventors: George W. McClurg, Jensen Beach, FL (US); John F. Carver, Palm City, FL (US); Gregory L. Cannon, Boynton Beach, FL (US); Timothy S. McDow, Jupiter, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 11/117,706

(22) Filed: Apr. 29, 2005

Related U.S. Application Data
(60) Provisional application No. 60/566,175, filed on Apr. 29, 2004.

(51) Int. Cl. G06K 9/00

(52) U.S. Cl. 382/127

(57) ABSTRACT

A surface pattern imaging device applicable to fingerprint and other surface imaging applications operates with an illumination source. In an embodiment, the illumination source is a narrow band green light, and an optical imaging path of the reader includes a green band pass filter and an infrared (IR) cutoff filter between the surface of interest and an image sensor. The filters prevent ambient light outside the green range from reaching the image sensor. In an exemplary embodiment useful in fingerprint imaging, ambient light wavelengths in the green range are absorbed and blocked naturally by the finger, and therefore cannot pass through the finger into the imaging path. Ambient light in other ranges, particularly including the red and infrared ranges which may pass through the finger, is attenuated by the band pass and IR cutoff filters. The image sensor in the improved reader therefore receives the light reflected from the green illumination source, while interference from ambient light sources is substantially attenuated.

### CROSS-REFERENCE TO RELATED APPLICATIONS

This application claims the benefit of U.S. Provisional Application Ser. No. 60/566,175, filed Apr. 29, 2004, incorporated herein by reference in its entirety.

### BACKGROUND OF THE INVENTION

1. Field of the Invention

The present invention relates generally to eliminating the effects of ambient light (indoor or outdoor) on an image.

2. Background Art

Biometrics is the science and technology of authentication (i.e. establishing the identity of an individual) by measuring the person's physiological or behavioral features. The term is derived from the Greek words “bios” for life and “metron” for degree.

In information technology, biometrics usually refers to technologies for measuring and analyzing human physiological characteristics such as fingerprints, eye retinas and irises, voice patterns, facial patterns, and hand measurements; especially for authentication purposes.

In a typical biometric system, a person registers with the system when one or more of their physiological characteristics are obtained, processed by a numerical algorithm, and entered into a database. Ideally, when the person logs into the system at a later time all of their features match. If someone else tries to log in as the same person, their biometric information does not fully match, so the system will not allow them to log in.

Performance of a biometric system is usually referred to in terms of the false accept rate (FAR), the false non-match or reject rate (FRR), and the failure to enroll rate (FTE or FER). In real-world biometric systems the FAR and FRR can typically be traded off against each other by changing parameters. One of the most common measures of real-world biometric systems is the rate at the setting at which both accept and reject errors are equal: the equal error rate (EER), also known as the cross-over error rate (CER). The lower the EER or CER, the more accurate the system is considered to be. Current technologies have widely varying Equal Error Rates (EER) from as low as 60% to as high as 99.9%.

Among all the biometric techniques, fingerprint-based identification is one of the oldest and most accurate methods which has been successfully used in numerous applications. Everyone is known to have unique, immutable fingerprints. A fingerprint is made of a series of ridges and furrows on the surface of the finger. The uniqueness of a fingerprint can be determined by the pattern of ridges and furrows as well as the minutiae points. Minutiae points are local ridge characteristics that occur at either a ridge bifurcation or a ridge ending. To implement fingerprint-based identification, an image or imprint of the fingerprint has to be acquired.

Similarly, an image of any uniquely identifiable skin surface can be used for identification. In addition to a single fingerprint, multiple fingertip images can be used for this purpose. In addition, images of the palm or the entire hand can be used as biometric identifiers.

In each of these identifying methods, a scanning process is used to acquire data representing a person's skin pattern characteristics. This allows the recognition of a person through quantifiable physiological characteristics that verify the identity of an individual. Optical methods are often used to obtain a visual image of the surface data of interest. In the case of fingerprint identification, a common optical data capture method includes placing one or more fingertips on a translucent platen. Beneath the platen, light reflected from the fingertips is directed through an optical path to an imaging device that captures image data.

However, the inventors have found that ambient light, which might be natural or artificial, often interferes with the acquisition of an optical image of a fingerprint. Therefore, there is a need for an improved fingerprint sensor system that overcomes the imaging problems created by the presence of various forms of ambient light.

### SUMMARY OF THE INVENTION

A method for obtaining an improved optical image of a fingerprint overcomes degradation of the quality and contrast of the image by minimizing the effects of ambient light. In an exemplary embodiment, the method comprises illuminating an object to be imaged with light that includes a predetermined wavelength, filtering the reflection with a band pass filter that passes the predetermined wavelength, and capturing the image with an image sensor.

In an embodiment, an optical sub-system between a skin surface and an image sensor includes an illumination source enabled to emit light including a predetermined wavelength onto the skin surface, and a filter disposed in the optical path created by the optical sub-system between the skin surface and the image sensor and enabled to pass the reflection of the predetermined wavelength.

Additional features and advantages of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed. Neither the summary nor the detailed description are intended to limit the scope of the claims in any way.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a side sectional view of a prism-type fingerprint scanner.

FIG. 2 is a side sectional view of the sensor of FIG. 1 showing the effects of ambient sunlight on the system.

FIG. 3 is a side sectional view of a sensor designed according to one embodiment of the present invention.

The present invention will now be described with reference to the accompanying drawings. In the drawings, some like reference numbers indicate identical or functionally similar elements. Additionally, the left-most digit(s) of most reference numbers identify the drawing in which the reference numbers first appear.

### DETAILED DESCRIPTION OF THE PREFERRED EMBODIMENTS

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

The present invention will be described in terms of an embodiment applicable to fingerprint scanning and overcoming imaging problems created by the presence of various forms of ambient light. It will be understood that the essential fingerprint scanning concepts disclosed herein are applicable to a wide range of skin surface imaging technologies, biometric systems, architectures and optical hardware elements. Thus, although the invention will be disclosed and described in terms of examples in the field of enhancing the quality of a fingerprint image by overcoming the effects of ambient light, the invention is not limited to this field.

Embodiments of the present invention provide, among other things, improved apparatus and methods for substantially eliminating the effects of ambient light (indoor or outdoor) on a fingerprint image. Exemplary embodiments will now be described in detail with reference to the drawings.

Terminology

To more clearly delineate the present invention, an effort is made throughout the specification to adhere to the following term definitions consistently.

The term “finger” refers to any digit on a hand including, but not limited to, a thumb, an index finger, middle finger, ring finger, or a pinky finger.

The term “skin surface” includes but is not limited to the surface of one or more fingers, palms, toes, foot, hand, palm, etc.

The term “print” can be any type of print including, but not limited to, a print of all or part of one or more fingers, palms, toes, foot, hand, etc. A print can also be a rolled print, a flat print, or a slap print.

The term “hand print,” can include any region on a hand having a print pattern, including thenar and hypothenar regions of the palm, interdigital regions, palm heel, palm pocket, writer's palm, and/or fingertips.

The term “live scan” refers to a capture of any type of print image made by a print scanner.

The term “non-planar prism” includes a prism having a non-planar platen surface that extends around all or part of an axis of the prism, and whose non-planar platen surface allows for total internal reflection of light. A non-planar platen surface allows a print pattern (such as, a print pattern on a hand, a palm pocket, a writer's palm, a writer's palm with fingertips), or other hand characteristic images, to be captured. An example of this type of prism can be an approximately conically-shaped prism. Other examples can be approximately spherically shaped prisms, curved prisms, and the like.

A platen can be movable or stationary depending upon the particular type of scanner and the type of print being captured by the scanner.

The terms “fingerprint scanner”, “scanner”, “live scanner”, “live print scanner,” and “print scanner” are interchangeable, and refer to any type of scanner which can obtain an image of a print pattern on all or part of one or more fingers, palms, toes, feet, hands, etc. in a live scan. The obtained images can be combined in any format including, but not limited to, an FBI, state, or international ten print format.

Example Fingerprint Scanning System

FIG. 1 is a side sectional view of a prism-type fingerprint scanner 100. In the example shown, an illumination source 102, which may be a green light source, emits light that passes through a prism 112 and is directly imaged onto the image sensor 104 by an optical sub-system 106. Prism 112 has a platen surface 110 against which finger 114 is placed. Finger 114 has fingerprint ridges 108 that contact platen surface 110.

The fingerprint scanner 100 in FIG. 1 uses total internal reflection (TIR) to capture a fingerprint. TIR is an optical phenomenon. When light crosses media with different refractive indices, the light beam will be bent at the boundary between the two media. At a certain angle of incidence known as the critical angle, light will stop crossing the boundary but instead reflect back internally at the boundary surface. TIR occurs only at a high refractive index or a low refractive index boundary and not the other way around. For example, if the right conditions exist, TIR will occur when passing from glass to air, but will not occur when passing from air to glass. The fingerprint scanner 100 in FIG. 1 uses a prism 112 to achieve the effects of TIR. The prism 112 can be used to refract light, reflect it or to disperse it into its constituent spectral colors and is traditionally built in the shape of a right prism with triangular base. The angle that a beam of light makes with the interface between the prism and air, as well as the refractive indices of the two media determine whether it is reflected or refracted or undergoes TIR. The monochromatic light source 102 is focused on the internal surface of platen 110 of prism 112 at an angle that allows TIR to take place.

Where the ridges 108 of a finger 114 contact platen surface 110, the TIR of prism 112 is broken. The light from illumination source 102 escapes the prism and enters the finger, where a significant amount of the light is absorbed. For the fingerprint valleys (areas of the fingerprint where air contacts the platen surface) the illumination source 102 will stay in TIR. These light rays continue through optical sub-system 106 and are focused onto image sensor 104. The optical sub-system 106 may consist of focusing lenses 116 and a mirror 118. The difference between (a) the light reflected off the internal surface of platen 110 onto image sensor 104 and (b) the light absorbed by fingerprint ridges 108 creates the contrast necessary to accurately reproduce a fingerprint image onto image sensor 104.

The image sensor 104 may be a charge coupled device (CCD) as is used in digital cameras and camcorders. A CCD is simply an array of light-sensitive diodes called photosites, which generate an electrical signal in response to light photons. Each photosite records a pixel, a tiny dot representing the light that hit that spot. Collectively, the light and dark pixels form an image of the scanned finger. Typically, an analog-to-digital converter in a scanner system 100 processes the analog electrical signal to generate a digital representation of this image. The image sensor 104 generates an image of the finger. Dark areas represent the ridges of the finger and lighter areas represent valleys between the ridges. Such bright-field illumination is illustrative and not intended to limit the present invention. Other illumination systems may be used including, but not limited to, other bright-field or dark-field types of illumination systems.

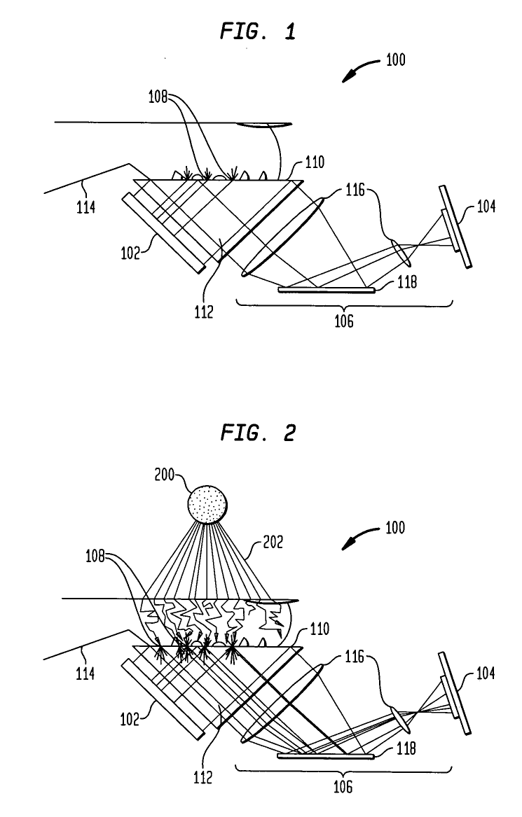

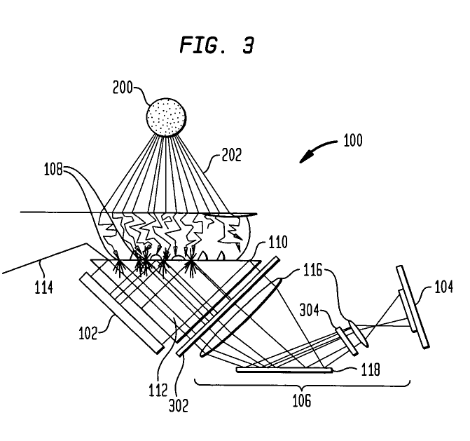

The inventors have determined that fingerprint scanning systems of the type shown in FIG. 1 may be adversely affected by the presence of ambient light 202 as shown in FIG. 2. Ambient light 202 may include any light not produced by the illumination source 102 of the fingerprint scanner, for example, sunlight from the Sun 200, reflected sunlight such as moonlight, and various sources of artificial light. As one example of ambient light, FIG. 2 shows the effects of sunlight 202 on the exemplary fingerprint scanner 100 of FIG. 1. As shown in FIG. 2, the longer wavelengths of light (red and infrared) can pass through the finger 114, enter prism 112 through fingerprint ridges 108, and thereby decrease the contrast of the fingerprint image at image sensor 104. Under certain circumstances the fingerprint can be completely washed out by the ambient light 202 and image sensor 104 will not obtain a useful fingerprint image.

### Example Embodiment

In one embodiment, the described method operates with a fingerprint scanner using a bright field illumination method. As seen in FIG. 3, in an embodiment that operates effectively with a green illumination source 102, a green band pass filter 302 and an infrared (IR) cutoff filter 304 are provided in optical path 106. The addition of filters in this embodiment prevents the unwanted external ambient light from reaching image sensor 104. Ambient light in the green range will not pass through the finger as these are shorter wavelengths and are absorbed and blocked naturally by the finger 114. Ambient light in the red and infrared ranges have longer wavelengths and will pass through finger 114 but will be substantially attenuated or blocked by band pass filter 302 and IR cutoff filter 304. Thus, image sensor 104 will receive the light reflected from green illumination source 102 without substantial interference from ambient light source 202 or other ambient light sources.

The embodiment shown in FIG. 3 is merely exemplary, and there are numerous ways to implement filters to similarly achieve desirable results. For instance the green band pass filter 302 and infrared cutoff filter 304 may each be located anywhere in the optical sub-system 106, that is, each may be placed at any desired location between prism 112 and image sensor 104. Although not shown in FIG. 3, each possible location and combination of locations of these two filters is contemplated within the scope of the present invention.

In another embodiment, band pass filter 302 and IR cutoff filter 304 are combined as a single optical element. In yet another embodiment, infrared cutoff filter 304 is implemented using a cold reflector mirror. In another optional embodiment, filters 302 and 304 are implemented using optical coatings on prism 112, one or more optical elements in optical sub-system 106, or image sensor 104. It is important to note that the mirror 118, lenses 116 and the illumination system in this example are only drawn to illustrate one such method for implementation.

In another embodiment, it is possible to use a non-planar prism instead of a planar prism 112. In yet another embodiment, the skin surface being imaged need not be placed on a platen surface 110 that requires physical contact.

In other embodiments, the image sensor 104 may be a phototransistor, a Contact Image Sensor (CIS), a Complimentary Metal Oxide Semiconductor (CMOS) or any other device capable of capturing skin surface pattern data focused on it via optical sub-system 106.

In a preferred embodiment an illumination source 102 of green light is used since the finger 114 absorbs more light at shorter wavelengths. In other embodiments light of a different wavelength/color that is substantially absorbed by finger 114 or another skin surface may be used. In another embodiment, if an illumination source 102 of a different wavelength/color is used, a band pass filter 302 corresponding to that wavelength/color will have to be used in conjunction with it.

The illumination source 102 in the current embodiment may be an array of light-emitting diodes (LEDs) that emit monochromatic light in a desired wavelength range. In other embodiments, the illumination source 102 may be another light source capable of emitting monochromatic light such as a laser light source. In the physical sense however, no real source of electromagnetic radiation is purely monochromatic, since that would require a wave of infinite duration. Even sources such as lasers have some narrow range of wavelengths within which they operate.

In the current embodiment the optical sub-system 106 consists of lenses 116 and mirror 118. In other embodiments the optical sub-system 106 may consist of the prism 112 and/or the optical filters 302 and 304 as shown in FIG. 3 or any combination thereof. In other embodiments, the optical sub-system 106 might use other optical elements, instead of lenses 116 and mirror 118, that have an equivalent effect of creating an optical path between finger 114 and image sensor 104.

While the embodiment presented herein uses a fingerprint as an example, it is obvious to a person skilled in the relevant art(s) to apply it to hand prints or any other skin surface pattern data. The embodiments presented use a planar prism 112 but it is obvious to a person skilled in the relevant art(s) to use any optical device (such as a non-planar prism, holographic optical element, or other means) that allows TIR for a fingerprint image to travel from the surface of finger 114 to the image sensor 104 along an optical path provided by optical sub-system 106.

Green band pass filter 302 is illustrative. Any short-wavelength band pass filter can be used that passes light having a wavelength shorter than red light. For example, a band pass filter that passes light having a wavelength less than about 600 nanometers (nm.) can be used. Such a band pass filter can include but is not limited to an amber band pass filter, amber/green band pass filter, green band pass filter or other shorter wavelength band pass filter.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the patent claims and their equivalents.

1. A method comprising:
a) illuminating a skin surface with light including at least one pre-determined wavelength;
b) filtering light reflected from the skin surface through a band pass filter that passes at least the predetermined wavelength;
c) focusing the filtered light onto an image sensor; and
d) capturing skin pattern data of the skin surface.

2. The method of claim 1, wherein the skin surface is disposed on a platen surface.

3. The method of claim 2, wherein the platen surface is a surface of a prism.

4. The method of claim 1, wherein the predetermined wavelength is a wavelength less than about 600 nm.

5. The method of claim 4, wherein the band pass filter passes light of a green wavelength, and further comprising: an infrared (IR) filter that substantially attenuates infrared light.

6. The method of claim 1, wherein the band pass filter is disposed in an optical path between the skin surface and the image sensor.

7. A skin surface imaging system comprising:
a) an optical sub-system including an optical path extending between a skin surface and an image sensor;
b) an illumination source enabled to emit light including at least one predetermined wavelength onto the skin surface; and
c) one or more optical filters disposed in the optical path;
wherein the one or more optical filters pass at least the predetermined wavelength and substantially attenuate a first range of wavelengths greater than the predetermined wavelength and a second range of wavelengths less than the predetermined wavelength.

8. The system of claim 7, wherein said skin surface is disposed on a platen surface.

9. The system of claim 8, wherein said platen surface is a surface of a prism.

10. The system of claim 7, wherein the predetermined wavelength is a wavelength less than about 600 nm.

11. The system of claim 10, wherein the one or more optical filters includes a band pass filter that passes at least the predetermined wavelength and an infrared (IR) filter that substantially attenuates infrared light.

12. A system comprising:
a) an optical path between a skin surface and an image sensor;
b) means for illuminating the skin surface with a light having at least one predetermined wavelength; and
c) means for filtering light reflected from said skin surface such that said at least one predetermined wavelength passes through, while attenuating wavelengths greater than and less than the predetermined wavelength.

13. The system of claim 12, wherein said skin surface is disposed on a platen surface.

14. The system of claim 12, wherein said platen surface is a surface of a prism.

15. The system of claim 12, wherein said predetermined wavelength is a wavelength of green light.

16. The system of claim 12, wherein said means for filtering comprises a band pass filter that passes light of at least said predetermined wavelength.

17. The system of claim 16, wherein said band pass filter passes light of a wavelength of green light.

18. The system of claim 16, wherein said means for filtering further includes an infrared (IR) cutoff filter.
